(19) United States
(12) Patent Application Publication
(10) Pub. No.: US 2006/0092003 A1
(43) Pub. Date: May 4, 2006

(54) Bulkhead proximity monitoring system

(76) Inventor: Scott Gardner, Gardner, KS (US)

Correspondence Address: BLACKWELL SANDERS PEPER MARTIN LLP, 4801 Main Street, Suite 1000, KANSAS CITY, MO, 64112, US

(21) Appl. No.: 10/966,998

(22) Filed: Oct. 15, 2004

(51) Int. Cl. G08B 21/00; G08B 1/08

(52) U.S. Cl. 340/431; 340/686.1; 340/539.23

(57) ABSTRACT

A bulkhead proximity indication system provides an alert for the operator of a vehicle regarding whether one of a set of bulkheads is outside an acceptable range of distance from a portion of a vehicle such as a tractor trailer. The system includes a base monitoring unit in communication with a plurality of remote locating units, as well as an alarm in communication with the base monitoring unit to indicate proximity conditions with respect to the base monitoring unit coupled with the vehicle portion for remote locating units mounted with the bulkheads.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The transportation of goods in commerce often involves the use of semi-trailer trucks, commonly referred to as “tractor trailers” or “semis”. These semi-trailer trucks generally consist of a large truck or tractor portion and a trailer. The tractor portion has a cab where a driver and occupants are carried, and which provides propulsion for the entire semi. The trailer is pulled by the tractor portion, and is designed to be the hauler portion of the semi, carrying various types of goods. The vast size of the trailer of a semi is useful in that a large volume of goods may be transported together at one time, producing greater efficiencies in the shipping of goods to various locations. At the same time, the sheer volume of the average-sized trailer may be more than is necessary for shipping a particular kind of good to one or more entities (e.g., retailers or distributors) on a given travel route, or for shipping various goods for a single entity.

A popular solution to this dilemma is to employ repositionable bulkheads within the trailer. These bulkheads serve to divide the area within the trailer into a subset of cargo units. For example, two bulkheads positioned between the front wall and rear doors of a trailer can divide the same into a forward cargo unit, a middle cargo unit, and a back cargo unit. The configurable nature of the trailer when using such bulkheads allows for the segregation of groups of goods into one or more of the cargo units. This segregation may be arranged by the goods specific entities are supposed to receive, or by class of goods. By dividing out areas for different classes of goods, a first group of items that must be kept within a narrow range of temperatures may be environmentally separated from a second group of items that must be kept within a different temperature range, or for which no narrow temperature range is necessary. For instance, a refrigeration unit may be coupled to the front area of the trailer to provide refrigerated air into the forward cargo unit where the first group of items, specifically food items susceptible to spoliation, are to be kept, while the second group of items not requiring any refrigeration may be sequestered in the middle cargo unit. At the same time, the bulkheads can often be removed from the trailer when subdividing cargo areas within the trailer is not necessary.

Because of the utility of trailer bulkheads, their use is widespread in the road-based cargo industry, as well as in other shipping industries where other types of trailers and cargo containers are utilized. However, the removable nature of some bulkhead types increases the likelihood that such bulkheads will be lost a point where goods move into and out of the trailer. Persons unloading cargo may, for instance, place the bulkheads outside of the trailer in order to gain an unobstructed access to remove goods from within the trailer. If the semi driver does not monitor whether the bulkheads are returned to the trailer, the driver may drive off without them and fail to realize this fact until they are far away from the unloading point. Shipping companies that utilize this bulkhead system are therefore concerned about costs associated with losing bulkheads, and the need for more easily notifying drivers about missing bulkheads while the driver is still in a position to easily recover them.

### BRIEF SUMMARY OF THE INVENTION

A bulkhead proximity indication system of the present invention servers to alert users when one of a set of bulkheads is outside an acceptable range of distance from a portion of a vehicle such as a tractor trailer. The system includes, in one aspect, a base monitoring unit in two-way communication with a plurality of remote locating units, as well as an alarm in communication with the base monitoring unit to indicate proximity conditions. The base monitoring unit includes a transmitter for transmitting polling signals, a receiver for receiving signals from the remote locating units, and a responder to selectively generate a response based on received signal activity. Each remote locating unit includes a receiver for receiving the polling signals from the base monitoring unit and a transmitter for transmitting signals in response to the polling signals. The base monitoring unit is to be coupled with a vehicle component (e.g., the trailer) and each remote locating unit is positioned on one of the bulkheads. The alarm, based on the response generated by the base monitoring unit, provides a proximity indication that can be perceived by a user (e.g., the driver) so that the user knows whether the bulkheads are not in a proper location, such a, for example, within or just outside of the trailer. One exemplary alarm type is a visual and/or audible indication of whether the base monitoring unit senses the presence of all remote locating units mounted on the bulkheads that are associated with the particular base monitoring unit.

### BRIEF DESCRIPTION OF THE SEVERAL VIEWS OF THE DRAWING

FIG. 1 is an illustrative view of the environment in which the system of the present invention may be implemented;

FIG. 2 diagramically shows the system of the present invention coupled with a vehicle and associated bulkheads;

FIG. 3 is a block diagram of one embodiment of the components of the system of the present invention;

FIG. 4 is a fragmentary illustrative view of the system environment of FIG. 1 further showing the alarm; and

FIG. 5 a flow diagram of one method for monitoring proximity conditions of bulkheads with respect to vehicle components.

### DETAILED DESCRIPTION OF THE INVENTION

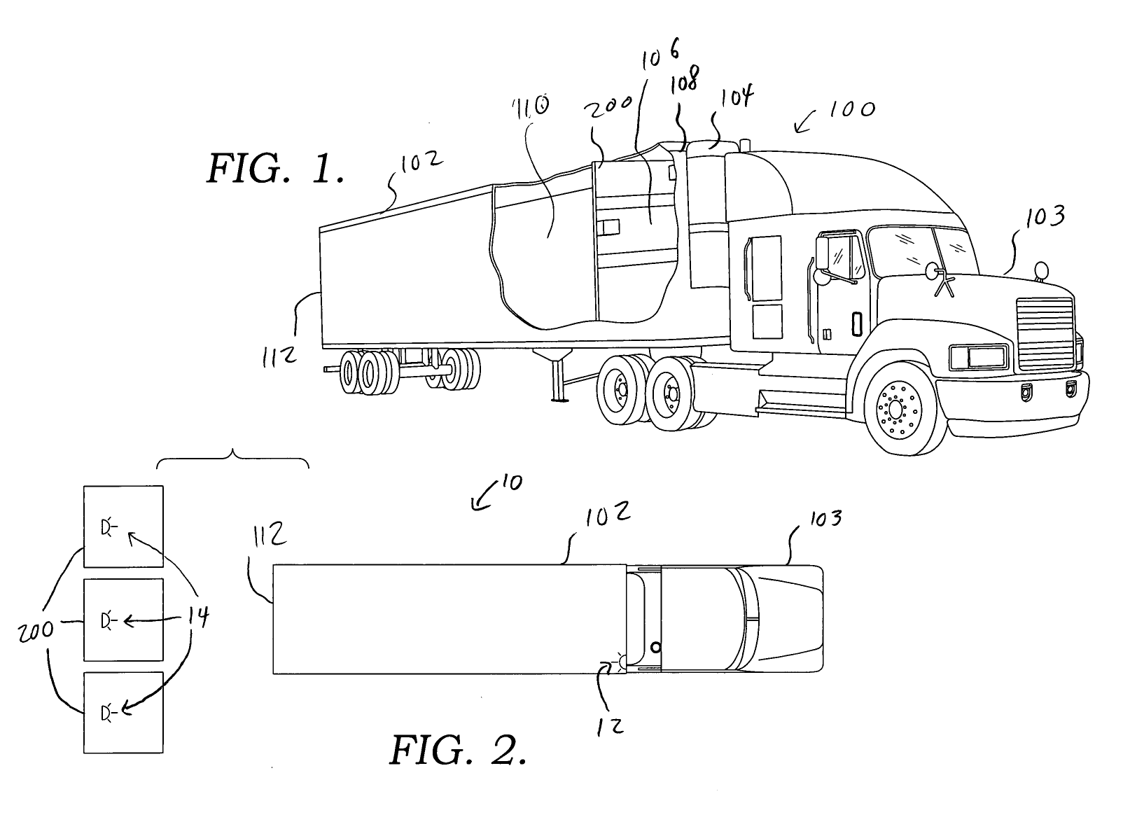

Turning now to the drawings, and initially to FIGS. 1 and 2, the environment in which the present invention is implemented is shown. More specifically, a bulkhead proximity indication system 10 is configured for coupling with a portion or component of a vehicle 100 and with a plurality of bulkheads 200 that are used within a trailer 102 of the vehicle 100. For instance, the vehicle component may include the trailer 102 or the tractor 103 portion of the vehicle 100 (where the vehicle 100 in this case is a semi-trailer truck).

The bulkheads 200 provide compartmentalization of the trailer 102 so that various separate cargo units can be formed therein. The construction of bulkheads 200 is well-known in the art, and includes the use of various framing materials to form a moveable wall barrier. The bulkheads 200 may include insulative materials (foams, etc.) when used to sequester items within a climate controlled area (e.g., a refrigerated zone). For instance, a refrigeration unit 104 may be mounted with the trailer 102 to supply refrigerated air into a forward region of the trailer 102. With the bulkhead 200 depicted in FIG. 1 in position within the trailer 102, a forward cargo unit or zone 106 between the bulkhead 200 and a front wall 108 of the trailer 102 may be cooled to a temperature appropriate for the type of items to be transported therein. A rearward cargo zone 110 not requiring the climate control provided by the refrigeration unit 104 is thereby formed between the bulkhead 200 and the rear doors 112 of the trailer 102. As should be understood, the forward and rearward cargo zones 106, 110 are but one potential compartmentalization configuration, and a single or multiple bulkheads 200 may be utilized within the trailer 102 to create a desired arrangement for sequestering items for transportation.

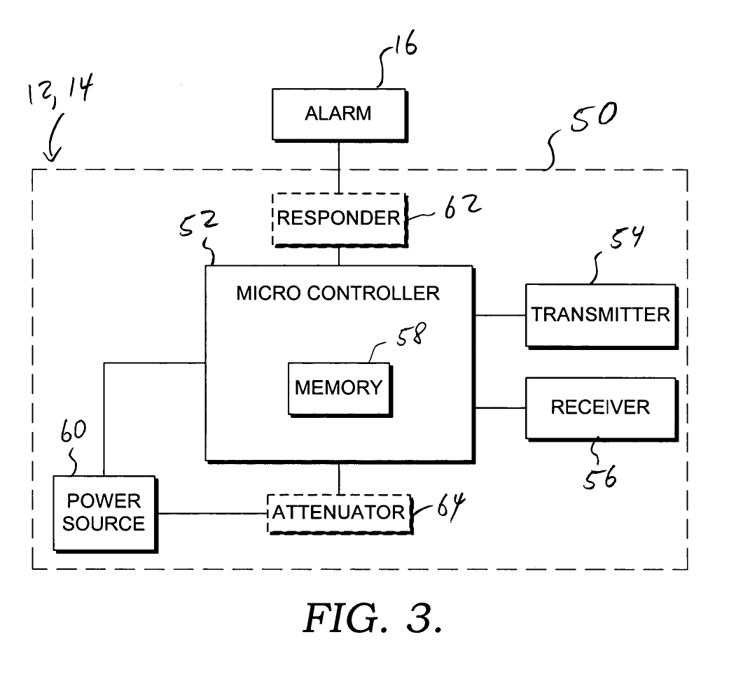

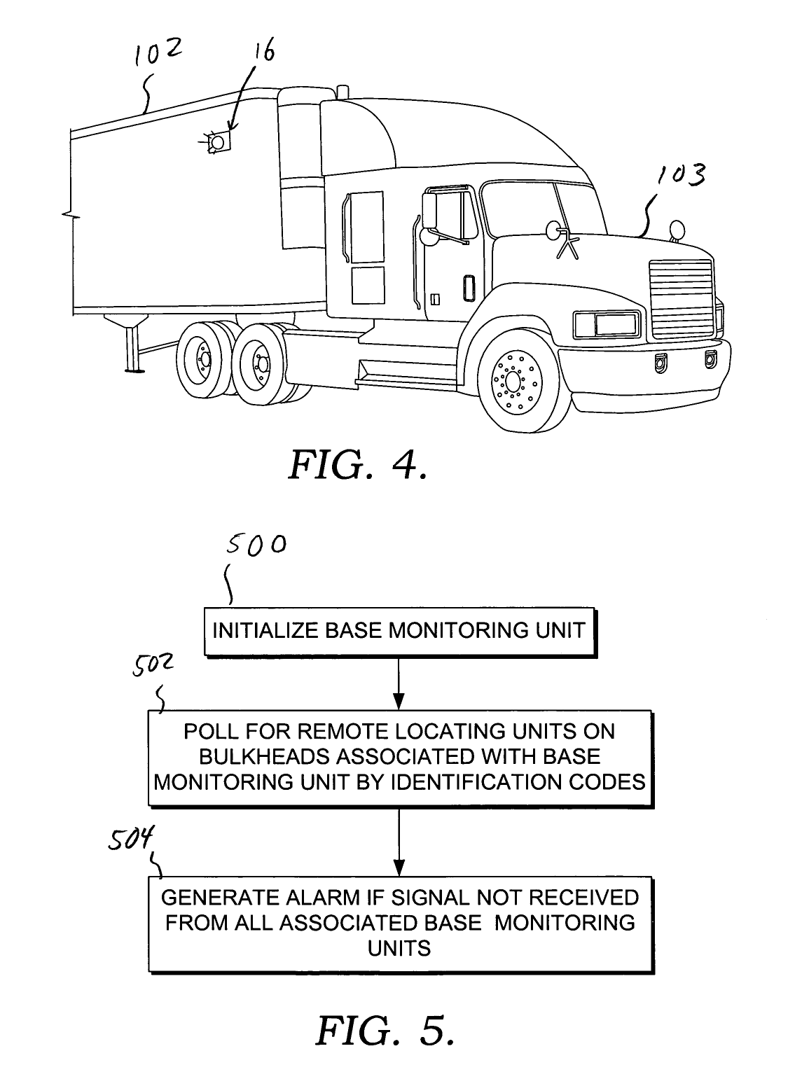

FIG. 2 shows the system 10 components, including a base monitoring unit 12 coupled with the trailer 102 and a plurality of remote locating units 14 configured to communicate with the base unit 12 in order to notify the base unit 12 as to whether the remote units 14 are within an acceptable range of distance, or “proximity”. As can be seen in FIGS. 3 and 4, an alarm 16 is also communicatively coupled with the base monitoring unit 12 to provide an indication of proximity conditions based on communications from the remote units 14 that are recognized by the base unit 12.

One embodiment of the components of the bulkhead proximity indication system 10 is shown in detail in FIG. 3. Area 50 encompasses the circuitry that forms both the base monitoring unit 12 and remote locating units 14, but with dashed lines used to depict various components that are unique to one or the other of the base unit 12 or remote units 14. A Micro controller 52 directs general electronic operations of the each of the base monitoring unit 12 and remote locating units 14. Also, indications provided by the alarm 16 are directed by the micro controller 52 of the base unit. The micro controller 52 receives various inputs and generates signals to direct operation of a transmitter 54 and a receiver 56. A memory device 58 is preferably embedded with the micro controller 52, and may include various types of volatile and nonvolatile memory such as RAM, ROM, EEPROM, etc., used to store executable programs to control operation of the micro controller 52, as well as other information which may be erased and written over from time to time. For example, in the case of the base monitoring unit 12, the memory device 58 may store identification codes of the various remote locating units 14 that are associated with the base unit 12. A power source 60 provides the power necessary for operation of the circuitry in area 50. For the remote locating units 14, the power source 60 may be a battery since the units are movable with the bulkheads 200 outside of the trailer 102. The power source 60 of the base monitoring unit 12, in contrast, may be either of a battery or the power source of the trailer 102 or tractor 103, depending on where the base unit 12 is mounted. For instance, the base monitoring unit could share a power source with the refrigeration unit 104. It should also be noted that the base monitoring unit 12 preferably provides the power for operation of the alarm 16. Additionally, within the base monitoring unit 12 is a responder 62 serving as the gateway to proximity indication by the alarm 16. The responder 62 acts to initiate certain condition for the alarm 16 based on the received signal activity from the remote locating units 14.

Exemplary circuitry that may be employed in the system 10 includes Texas Instruments MSP430F1222 as micro controller 52, Motorola MC33493 OOK as transmitter 54, and Micrel MICRF008 OOK as receiver 56. As such, the base monitoring unit 12 and remote locating units 14 may each be formed as a transceiver. Additionally, the signals transmitted by transmitter 54 may include carrier signals in the frequency range of around 387 MHZ or other radio-frequency range, and the receiver 56 is configured to pick up on such signals in the frequency range.

By employing the circuitry of the present invention shown in FIG. 3, the detection of carrier frequency by the receiver 56 indicates a first logic state and the lack of carrier frequency detection indicates a second logic state. This enables the responder 62 to decide how to the alarm 16 is to produce a proximity indication. For instance, if the first logic state is found (i.e., a valid response signal has been detected from all of the remote locating units 14), denoting a positive or acceptable proximity condition, the responder 62 may either (1) avoid providing a signal to the alarm 16, whereby the alarm will not give a visual or audible indication of a violation of proximity, or (2) provide a signal to the alarm 16 that alerts the driver or operator that proximity is acceptable (e.g., solid illumination of light). On the other hand, if the second logic state is found (i.e., a valid response signal not detected within a predetermined amount of time after the transmission of a polling signal from the base monitoring unit 12), denoting a negative or unacceptable proximity condition, the responder 62 preferably provides a signal to the alarm 16 that alerts the driver of that proximity is unacceptable for at least one bulkhead 200 (e.g., flashing illumination of light, loud buzzer or other sound, etc.).

In a preferred operating method shown in FIG. 5, a first step 500 requires the base monitoring unit 12 to be initiated, which may include turning the unit 12 “on”. At a next step 502, the base monitoring unit 12 will transmit through transmitter 54 a polling signal seeking a response. Polling typically takes place at set predetermined periodic intervals when the system 10 is turned on by the operator/driver. Preferably, preloaded into the memory device 58 of the base monitoring unit 12 are the identification codes for all remote locating units 14 that may be loaded with specific bulkheads 200 that are desired to be associated with a particular trailer 102. One identification code could be used for a grouping or family of remote locating units 14, and thus of the set of associated bulkheads 200 specifically linked to a given trailer 102. More preferably, each remote locating unit 14 would have its own associated identification code, so that all of the bulkheads 200 of a given owner of a fleet of trailers 102, for example, could use the bulkheads 200 interchangeably among the fleet of trailers 102. As such, the polling signal may include one or more signals each including at least one identification code associated with each of the remote locating units 14. Upon receiving the polling signal with identification code corresponding to and recognized by the particular remote locating unit 14, the unit 14 will transmit a reply signal to indicate receipt of a valid polling signal. The base monitoring unit 12 then detects the reply signal as a positive proximity condition if signals are received from all remote locating units 14 that were polled. In one embodiment, a positive proximity condition further requires that the reply signals each include one of the identification codes transmitted by the unit 12 to ensure that the unit 12 is not detecting signals from remote locating units 14 of adjacent trailers 102. If not, then a negative proximity condition is realized by the base monitoring unit 12. At step 504, the alarm 16 may generate an indication of the proximity condition detected.

Another operating scheme includes the base monitoring unit 12 not having the set of identification codes for the remote locating units 14 “preloaded” into memory. This contemplates the operator first instructing the remote locating unit (through a user interface (not shown) coupled with the micro controller 52, in one example simply the on/off switch of the base unit 12 where turning the unit 12 “on” provides the instruction) to poll for remote locating units 14 and their identification codes, and receiving a response from those remote units 14 within the range of transmission of the base unit 12 (typically only within the trailer 102), the response including the identification codes, which are then stored in the memory device 58 of the micro controller 52 for use in normal polling operation.

With the remote locating units 14, an attenuator 64 may be provided to reduce the power provided by the power source 60 to the micro controller 52, which may both control operation of and supply power to the transmitter 54. By lowering the amount of power supplied to the transmitter 54, a weaker signal will be sent out, and thus, the remote locating units 14 will have to be positioned closer to the base monitoring unit 12 for a signal to be detected. This allows for selected proximity ranges by the operator. As one example, if the operator only wants the bulkheads 200 on which the remote locating units 14 are mounted to be no more than about 80 feet from the base monitoring unit 12 (i.e., typically just outside of the rear of the trailer 102, and assuming theoretically that the structure of the trailer 102 or other structures do not degrade or block the transmitted signals), then an appropriate proximity setting may be selected and the attenuator 64 engaged. Alternatively, the attenuator 64 may be located directly between the power source 60 and the transmitter 54 to achieve the same effect without involving the micro controller 52.

Another optional component for the system 10 includes an accelerometer (not shown) coupled to the micro controller 52 of the base monitoring unit 12. Upon the accelerometer sensing movement of the base monitoring unit 12 (i.e., movement of the trailer 102 and/or tractor 103), or upon some set amount of time thereafter, the base unit 12 begins the transmission of periodic polling signals seeking the status of the remote locating units 14. This system configuration takes into account that bulkheads 200 are typically not moved far away from a vehicle 100 when it is stationary at a loading or unloading point, but motion indicates the tractor trailer is leaving such a point, which is the critical time to recover the bulkheads 200.

Still further, the remote locating units 14 may enter a “sleep” mode during typical operation when a signal transmitted from the base monitoring unit 12 has not been detected for some amount of time. The remote locating unit 14 will reduced the power drawn by the components of the unit 14 for certain periods of time, and then will briefly “wake up” and increase normal power flow to components necessary to “listen” for any transmitted signals. For example, at least the receiver 56 (and if it draws power through the micro controller 52, then also the micro controller 52) will be powered up during the listening phase. If the remote locating unit 14 detects a transmission signal from the base monitoring unit 12 that includes the correct identification code, then the remote unit will fully power up and resume normal operations, including transmission of a reply signal.

In another embodiment providing reduced functionality and a more basic design, the base monitoring unit 12 may be configured without a transmitter 54, and the remote locating units 14 may be configured without a receiver 56. In this scenario, the base monitoring unit 12 would not transmit a polling signal asking for a response from the remote locating units 14, and such remote units 14 would likewise not be listening for such a polling signal. Instead, the remote locating units 14 would periodically transmit (e.g., at preestablished time intervals) a signal notifying of the presence of such units, and the base monitoring unit 12 would be listening for such transmissions. The alarm would 16 only operate when the base monitoring unit 12 is turned on and is in a full operating mode, and the identification codes of the remote locating units 14 may still be preloaded into the memory of the base monitoring unit 12 so that the base unit 12 listens for transmitted signals that include the recognized identification codes.

Since certain changes may be made in the above invention without departing from the scope hereof, it is intended that all matter contained in the above description or shown in the accompanying drawing be interpreted as illustrative and not in a limiting sense.

1. A system providing compartmentalization within a trailer of a vehicle and a proximity indication with respect to at least one of the vehicle and the trailer, comprising:
a plurality of moveable bulkheads adapted to be selectively positioned in the vehicle trailer, each bulkhead having coupled thereto a remote locating unit for transmitting signals;
a base monitoring unit mounted with one of the vehicle and the trailer, and including,
means for receiving signals transmitted by the remote locating units, and
means for selectively generating a response based on received signal activity; and
alarm means in communication with the means for selectively generating a response for indicating proximity conditions of the plurality of bulkheads based on the response generated.

2. The system of claim 1, wherein the means for selectively generating a response is adapted to engage in response generation when the means for receiving signals fails to detect a signal from any one of the remote locating units over a predetermined time interval.

3. The system of claim 1, wherein the alarm means provides at least one of a visual and audible indication of proximity conditions.

4. The system of claim 3, wherein the alarm means is mounted onto the trailer.

5. The system of claim 3, wherein the proximity conditions include a positive condition where the means for receiving signals detects a signal from each of the remote locating units over a predetermined time interval, and a negative condition where the means for receiving signals fails to detect a signal from any one of the remote locating units over the predetermined time interval.

6. The system of claim 5, wherein the at least one of a visual and audible indication of proximity conditions includes illumination, the alarm means providing one of a first illumination effect or no illumination when the first condition is present and a second illumination effect when the second condition is present.

7. The system of claim 1, wherein the remote locating units and the base monitoring unit are radio-frequency transceivers.

8. The system of claim 7, wherein the base monitoring unit is adapted to transmit polling signals to the remote locating units to request a reply and each remote locating unit is adapted to transmitting a reply signal based on the receipt of least one of the polling signals.

9. The system of claim 8, further comprising an attenuator coupled with the base monitoring unit, the attenuator providing selective attenuation of the at least one polling signal.

10. The system of claim 8, wherein the polling signals include at least one identification code associated with the remote locating units.

11. The system of claim 10, wherein the at least one identification code includes a unique identification code for each one of the remote locating units.

12. The system of claim 10, wherein each of the remote locating units has a power supply and is adapted to enter a low-power consumption sleep mode after a predetermined amount of time from last receiving the at least one polling signal, and to be awoken from the low-power consumption sleep mode and enter a normal operating mode upon receiving the at least one polling signal containing at least one of the associated identification codes.

13. The system of claim 10, wherein the base monitoring unit further includes means for storing each of the identification codes.

14. The system of claim 10, wherein the reply signal transmitted by each of the remote locating units includes a reply signal denoting a positive proximity condition, and wherein each remote locating unit is adapted to transmit the reply signal denoting a positive proximity condition only upon one of the identification codes of the at least one polling signal being recognized by the particular remote locating unit as being associated therewith.

15. The system of claim 14, wherein the base monitoring unit generates a negative response upon the base monitoring unit failing to receive the reply signal denoting a positive proximity condition from any one of the remote locating units over a predetermined time interval, the negative response being presented by the alarm means as an indication of a negative proximity condition.

16. The system of claim 1, wherein the base monitoring unit is mounted within the trailer such that the system provides proximity indication with respect to the trailer.

17. The system of claim 1, wherein the base monitoring unit includes an accelerometer, the base monitoring unit transmitting at least one polling signal upon the accelerometer sensing movement of one of the vehicle and the trailer.

18. A method of monitoring a proximity condition for a plurality of moveable bulkheads with respect to at least one of a vehicle and a trailer of the vehicle, the method comprising the steps of:
transmitting signals from one or more of a plurality of remote locating units mounted with the plurality of moveable bulkheads configured for positioning within the trailer;
receiving of the transmitted signals by a base monitoring unit;
generating a response based on reception of the transmitted signals; and
providing a particular indication of the proximity condition for the plurality of bulkheads based on the response generated, the proximity condition including one of a positive condition where all of the moveable bulkheads are within an acceptable range of distance from at least one of the vehicle and the trailer, and a negative condition where any of the moveable bulkheads are outside of an acceptable range of distance from at least one of the vehicle and the trailer.

19. The method of claim 18, wherein the response generated based on reception of the transmitted signals includes a first response where the transmitted signals are received by the base monitoring unit from all of the plurality of remote locating units associated with the base monitoring unit over a predetermined time interval, and a second response where the transmitted signals are received by less than all of the plurality of remote locating units associated with the base monitoring unit over the predetermined time interval.

20. The method of claim 18, wherein the base monitoring unit is coupled with the trailer so that the particular proximity condition indicated for the plurality of bulkheads is one of the positive condition where all of the moveable bulkheads are within an acceptable range of distance from the trailer, and the negative condition where any of the moveable bulkheads are outside of an acceptable range of distance from the trailer.

21. The method of claim 18, wherein the particular indication of the proximity condition is dependent upon whether the base monitoring unit receives a qualifying transmitted signal from each of the plurality of remote locating units over a predetermined time interval.

22. The method of claim 18, further comprising the steps of:
transmitting at least one polling signal from the base monitoring unit; and
receiving of the at least one polling signal by the one or more of a plurality of remote locating units;
wherein the step of transmitting signals from the one or more of a plurality of remote locating units is in response to receiving of the at least one polling signal.

23. The method of claim 22, wherein the at least one polling signal includes identification codes associated with the plurality of remote locating units, and wherein signals are transmitted from the one or more of a plurality of remote locating units based on the identification codes.

24. The method of claim 18, wherein the particular indication of the proximity condition is provided by an alarm.

25. A bulkhead proximity indication system, comprising:
a base monitoring unit adapted for coupling with a vehicle component, the base monitoring unit including a transmitter for transmitting polling signals, a receiver for receiving signals and a responder selectively generating a response based on received signal activity;
a plurality of remote locating units adapted for coupling with a plurality of moveable bulkheads, each of the plurality of remote locating units including a receiver for receiving the polling signals and a transmitter for transmitting signals in response to the polling signals; and
an alarm in communication with the responder of the base monitoring unit for indicating proximity conditions of the plurality of moveable bulkheads based on the response generated by the responder.

26. The system of claim 25, wherein the vehicle component is a trailer such that the system provides proximity indication with respect to the trailer.

27. The system of claim 25, wherein the vehicle component is a truck cab such that the system provides proximity indication with respect to the truck cab.

28. The system of claim 25, wherein the responder is adapted to engage in response generation when the receiver of the base monitoring unit fails to detect a signal from any one of the plurality of remote locating units over a predetermined time interval.

29. The system of claim 25, wherein the alarm provides at least one of a visual and audible indication of proximity conditions which include a positive proximity condition where the receiver of the base monitoring unit detects a signal from each of the plurality of remote locating units over a predetermined time interval, and a negative proximity condition where the receiver of the base monitoring unit fails to detect a signal from any one of the plurality of remote locating units over the predetermined time interval.
